(19) United States
(12) Patent Application Publication
(10) Pub. No.: US 2011/0115733 A1
(43) Pub. Date: May 19, 2011

(54) TOUCH SENSING DISPLAY DEVICE WITH IN-CELL TOUCH PANEL

(75) Inventor: PO-SHENG SHIH, Miao-Li County (TW)

(73) Assignee: CHIMEI INNOLUX CORPORATION, Miao-Li County (TW)

(21) Appl. No.: 12/948,771

(22) Filed: Nov. 18, 2010

(30) Foreign Application Priority Data
Nov. 19, 2009 (TW) 98139411

(51) Int. Cl. G06F 3/041

(52) U.S. Cl. 345/173

(57) ABSTRACT

A touch sensing display device includes a touch panel and a signal processing circuit. The touch panel includes a plurality of pixel units, and the pixel units constitute a plurality of touch display units each comprising a touch sensing element. The touch sensing element is electrically coupled to a corresponding scanning line and electrically coupled to the signal processing circuit via a touch sensing line. A common voltage signal with a first polarity and an inversed second polarity is provided to the pixel unit. When the scanning line electrically coupled to the touch sensing element is provided with a scanning signal and the common voltage signal with the first polarity, a touch sensing signal generated by the touch sensing element is outputted to the signal processing circuit to enable the signal process circuit to generate a touch position indication signal.

### BACKGROUND

1. Technical Field

The present disclosure relates to touch sensing display devices, and more particularly to a touch sensing display device having a in-cell touch panel.

2. Description of Related Art

Touch sensing display devices, for example, in-cell type touch sensing display devices, are widely used in the electronic devices, such as mobile phones, game consoles, personal digital assistants (PDAs), and the like.

An existing in-cell touch sensing display device usually includes a liquid crystal display (LCD) panel with touch sensing elements built inside the LCD panel cells. A user can operate the touch sensing display device by performing a touch operation onto the LCD panel, and thereby applying a touch sensing signal to the touch sensing elements.

In particular, the LCD panel may further include a common electrode layer. In order to protect the liquid crystal molecules from decay or damage, an alternating circuit (AC) common voltage signal is provided to the common electrode layer. However, parasitic capacitors may exist between the common electrode layer and the touch sensing elements. The parasitic capacitors may cause the touch sensing signals applied to the touch sensing elements to be susceptible to interference due to a variation of the AC common voltage signal. Accordingly, the in-cell touch sensing display device has low stability and reliability.

What is needed is a touch sensing display device that can overcome the described limitations.

### SUMMARY

An aspect of the disclosure relates to a touch sensing display device includes a touch panel and a signal processing circuit. The touch panel includes a plurality of pixel units, and the pixel units cooperatively constitute a plurality of touch display units each comprising a touch sensing element. The touch sensing element is configured for providing a touch sensing signal when a touch operation is applied to the corresponding touch display unit. The signal processing circuit is configured for processing the touch sensing signal provided by the touch sensing element. The touch sensing element is electrically coupled to a corresponding scanning line and electrically coupled to the signal processing circuit via a touch sensing line. A common voltage signal is provided to the pixel unit, and the common voltage signal is an inversing-polarity signal with a first polarity and an inversed second polarity. When the scanning line electrically coupled to the touch sensing element is provided with a scanning signal and the common voltage signal with the first polarity, the touch sensing signal generated by the touch sensing element is outputted to the signal processing circuit to enable the signal process circuit to generate a touch position indication signal.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is a partial schematic diagram of a touch sensing display device according to a first embodiment of the present disclosure.

FIG. 2 is a partially side schematic view of one embodiment of the touch panel of the touch sensing display device of FIG. 1.

FIG. 3 is a circuit schematic view of one embodiment of a signal processing unit of signal processing circuit of the touch sensing display device shown of FIG. 1.

FIG. 4 shows waveforms of driving signals of the touch sensing display device of FIG. 1.

FIG. 5 is a partial schematic diagram of a touch sensing display device according to a second embodiment of the present disclosure.

FIG. 6 shows waveforms of driving signals of the touch sensing display device of FIG. 5.

FIG. 7 is a partial schematic diagram of a touch sensing display device according to a third embodiment of the present disclosure.

FIG. 8 shows waveforms of driving signals of the touch sensing display device of FIG. 7.

FIG. 9 is a partial schematic diagram of a touch sensing display device according to a fourth embodiment of the present disclosure.

FIG. 10 is a partially side schematic view of one embodiment of the touch panel of the touch sensing display device of FIG. 9.

FIG. 11 is a circuit schematic view of one embodiment of a signal processing unit of signal processing circuit of the touch sensing display device shown of FIG. 9.

FIG. 12 shows waveforms of driving signals of the touch sensing display device of FIG. 9.

FIG. 13 is a partial schematic diagram of a touch sensing display device according to a fifth embodiment of the present disclosure.

FIG. 14 shows waveforms of driving signals of the touch sensing display device of FIG. 13.

FIG. 15 is a partial schematic diagram of a touch sensing display device according to a sixth embodiment of the present disclosure.

FIG. 16 shows waveforms of driving signals of the touch sensing display device of FIG. 15.

### DETAILED DESCRIPTION

Reference will now be made to the drawings to describe certain exemplary embodiments of the present disclosure in detail.

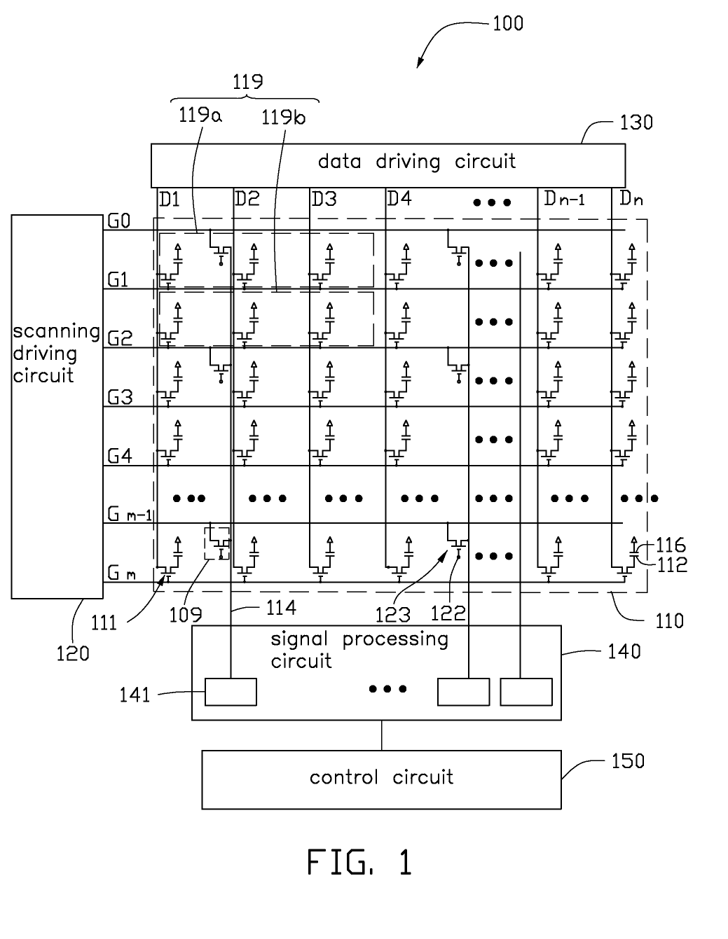

FIG. 1 schematically illustrates a partial circuit diagram of a touch sensing display device according to a first embodiment of the present disclosure. The touch sensing display device 100 includes a touch panel 110, a scanning driving circuit 120, a data driving circuit 130, a signal processing circuit 140, and a control circuit 150.

The touch panel 110 can be a LCD panel with touch sensing elements built therein. The touch panel 110 may include a total m+1 parallel scanning lines G0˜Gm, a total n parallel data lines D1˜Dn, and a total m×n pixel units Pij arranged as a matrix distribution (where i, j respectively represent the ith row and the jth column of the pixel matrix, and 1≦i≦m, 1≦j≦n). In particular, the scanning lines G0˜Gm may be perpendicular to the data lines D1˜Dn, and the pixel units Pij are defined by intersection of the scanning lines G0˜Gm and the data lines D1˜Dn.

Each pixel unit Pij includes a thin film transistor (TFT) 111 and a pixel electrode 112. A gate electrode of the TFT 111 is electrically connected to the scanning driving circuit 120 via a corresponding scanning line Gi (1≦i≦m), a source electrode of the TFT 111 is electrically connected to the data driving circuit 130 via a corresponding data line Dj (1≦j≦n), and a drain electrode of the TFT 111 is electrically connected to the pixel electrode 112. Moreover, in an exemplary embodiment, the touch panel 110 may further include a common electrode layer 116. The common electrode layer 116 may includes a plurality of common electrodes 116, and each common electrode 116 is configured in a respective pixel unit. In each pixel unit, the pixel electrode 112, the common electrode 116, and a liquid crystal layer (not shown) located between the pixel electrode 112 and the common electrode 116 cooperatively constitute a liquid crystal capacitor 115.

The m×n pixel units can be divided into a plurality of touch display units 119. In one embodiment, the touch display units 119 may also be arranged as a matrix distribution, each touch display unit 119 includes p×q pixel units, where, for example, p=3, q=2. In detail, each touch display unit 119 may include a first touch display sub-unit 119a and a second touch display sub-unit 119b adjacent to each other. For example, the first touch display sub-unit 119a and the second touch display sub-unit 119b may be respectively arranged in an ith row and an (i+1)th row of the pixel matrix, in the illustrated embodiment, i denotes an odd number. Each touch display sub-unit 119a, 119b may be constituted by 3*1 pixel units, which may respectively correspond to a red pixel unit, a green pixel unit, and a blue pixel unit.

Moreover, a touch sensing element 109 may be disposed in each touch display unit 119. The touch sensing element 109 may be located in the first touch display sub-unit 119a of the touch display unit 119, for example, be located within a selected one pixel unit Pij of the first touch display sub-unit 119a. The touch panel 110 can further include a plurality of touch sensing lines 114 parallel to the data line D1˜Dn. The touch sensing element 109 may provide a touch sensing signal to the signal processing circuit 140 by means of a corresponding one of the touch sensing line 114. In particular, the touch sensing element 109 located in the ith row of the pixel matrix may be electrically coupled to the scanning line Gi−1, and further be electrically coupled to the signal processing circuit 140 via the corresponding touch sensing line 114. Additionally, in one embodiment, all the touch sensing elements 109 located in a same column of pixel matrix are electrically coupled to the signal processing circuit 140 via a same touch sensing line 114.

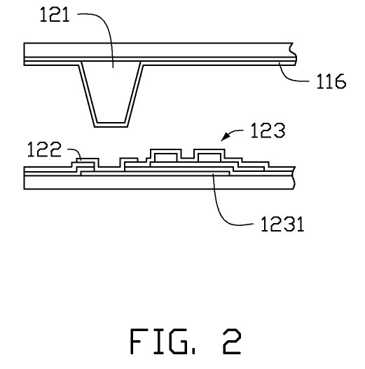

Referring also to FIG. 2, in one embodiment, the touch sensing element 109 in the touch display unit 119 may include a switch member 123 formed on a TFT substrate (not labeled), a touch sensing electrode 122 formed on the TFT substrate and adjacent to the switch member 123, and a protrusion 121 formed on a color filter (CF) substrate (not labeled) and located at a position opposite to the touch sensing electrode 122. The protrusion 121 is covered by a common electrode 116 formed on the CF substrate. The switch member 123 includes a control terminal 1231, which may be applied with an activation signal when an operator or user performs a touch operation onto the touch display unit 119 and thereby enabling the switch member 123 to be switched on.

In one embodiment, the switch member 123 may have a TFT structure having a gate electrode, a source electrode, and a drain electrode. The gate electrode of the switch member 123 may serve as the control terminal 1231, which extends to the touch sensing electrode 122 and thereby being electrically coupled to the touch sensing electrode 122. The source electrode of the switch member 123 is electrically coupled to the scanning line Gi−1, and the drain electrode of the switch member 123 is electrically coupled to the touch sensing line 114. With this configuration, when a user perform a touch operation onto the touch display unit 119, an external force may be introduced to the touch sensing element 109, and the protrusion 121 is pressed such that the common electrode 116 covering the protrusion 121 contacts the touch sensing electrode 122. Accordingly, a common voltage applied to the common electrode 116 by a common electrode circuit is transmitted, through the touch sensing electrode 122, to the control terminal 1231 of the switch member 123, and the common voltage acts as an activation signal to control the switch member 123 to be switched on. As such, the scanning signal transmitted in the scanning line Gi−1 servers as the touch sensing signal, and is provided to the signal processing circuit 140 through the touch sensing line 114.

The signal processing circuit 140 includes a plurality of processing modules 141, each of which corresponds to a respective row of touch display units 119, and is electrically coupled to the corresponding row of touch display units 119 via the touch sensing line 114. The processing module 141 is configured to process a touch sensing signal provided thereto through the through the touch sensing line 114.

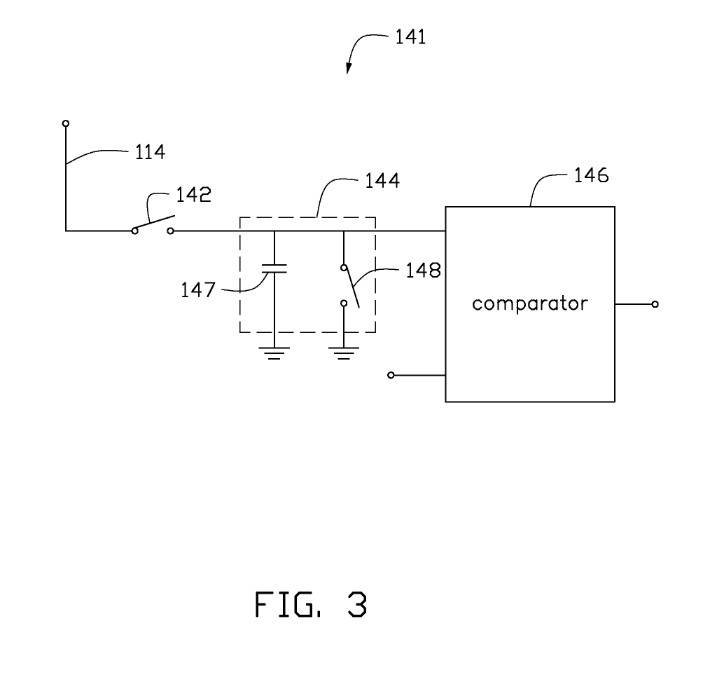

FIG. 3 schematically illustrates a circuit diagram of the processing module 141 according to one embodiment of the present disclosure. In the illustrated embodiment, the processing module 141 includes a controllable switch 142, a storage unit 144, and a comparator 146. One end of the controllable switch 142 is electrically coupled to the touch sensing line 114 for receiving the transmitted touch sensing signal, and the other end of the controllable switch 142 is electrically coupled to a first terminal of the comparator 146 via the storage unit 144, while a second terminal of the comparator 146 is configured to receive a reference signal. The controllable switch 142 can be switched on or switched off under control of a drive timing of the touch sensing display device 100, so as to determine whether to read and process the touch sensing signal transmitted by the touch sensing line 114. The storage unit 144 may include a storage capacitor 147 and a switch 148 electrically coupled in parallel between the first terminal of the comparator 146 and the ground. The comparator 146 may be a differential amplification comparator, which includes an in-phase input terminal serving as the first terminal, an inverting-phase input terminal serving as the second terminal, and an output terminal electrically coupled to the control circuit 150. The comparator 146 is configured to generate the touch position indication signal by comparing the touch sensing signal with a predetermined reference signal.

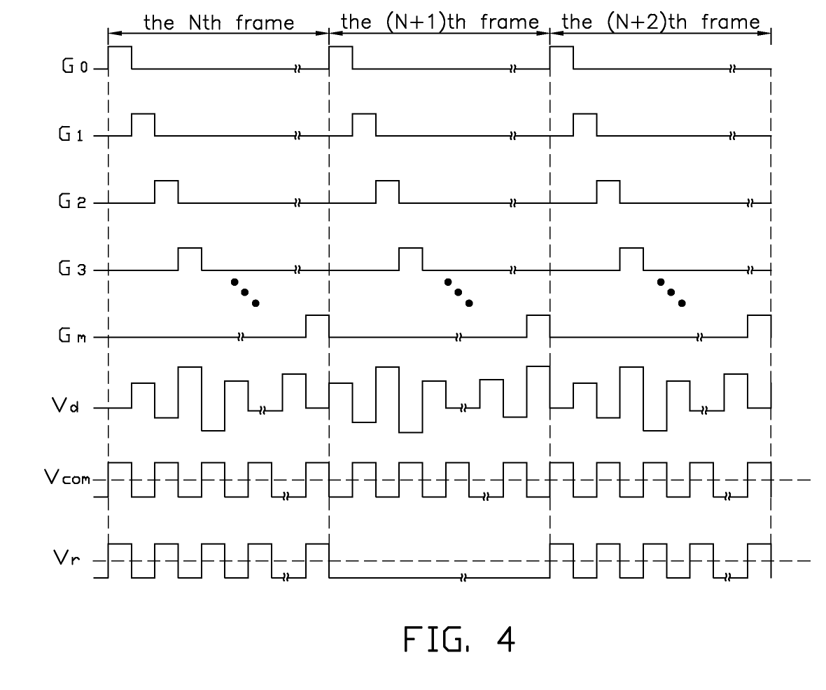

Referring to FIG. 4, in operation, the scanning driving circuit 120 generates a plurality of scanning signals G0˜Gm, and outputs the scanning signals G0˜Gm to the scanning lines sequentially so as to activate the pixel units Pij row by row. The data driving circuit 130 generates a plurality of data signals Vd, and outputs the data signals Vd to the corresponding activated pixel units Pij. Moreover, a common voltage signal Vcom is generated and provided to the common electrode layer 116. The data signal Vd and the common voltage signal Vcom cooperatively drive a corresponding pixel unit Pij to display a particular picture element, and an aggregation of picture elements displayed by all the pixel units in one frame period constitutes a picture that can be viewed by a user. In particular, the common voltage signal is an alternating circuit (AC) common voltage signal having a positive polarity signal and a negative polarity signal alternately with each other, that is, the common voltage signal is an inverse-polarity signal. Moreover, amplitude of the common voltage signal is variable, and can be set as desired.

An operation of the touch sensing display device 100 in responsive to a touch operation performed thereon is described as follow with reference to FIGS. 1-4. When a user operating the touch sensing display device 100 performs a touch operation onto the touch sensing display device, the touch sensing element 109 located in a position in which the touch operation is designated (i.e., a touch position) may sense the touch operation, and the protrusion 120 of the touch sensing element 109 is pressed to enable the common electrode layer 116 to contact the touch sensing electrode 122, such that the switch element 123 is switched on. During the corresponding scanning line Gi−1 coupled to the touch sensing element 109 being provided the scanning signal, the touch sensing element 109 can provide the scanning signal as a touch sensing signal to the touch sensing line 114.

Specifically, during an Nth frame, when the scanning line Gi−1 is provided with the scanning signal, the common electrode layer 116 is provided with a common voltage signal with a positive polarity and the controllable switch 142 is switched on under control of the control signal Vr. Due to the positive polarity common voltage signal, the switch member 123 is in on-state, and accordingly, the processing module 141 can read and process a touch sensing signal transmitted by the touch sensing line 114. In detail, the touch sensing signal is transmitted to the storage unit 144 via the touch sensing line 114 and the controllable switch 142, and is stored by the storage unit 144. The comparator 146 compares the touch sensing signal with a reference signal and correspondingly outputs a touch position indication signal to the control circuit 150, such that the control circuit 150 can determine coordinates of the touch position. The control circuit 150 can further execute corresponding touch operations according to the coordinates of the touch position, and control the touch sensing display device 100 or electronic device using the touch sensing display device 100 to perform corresponding actions.

Moreover, during the Nth frame, when the next scanning line Gi is provided with the scanning signal, the common electrode layer 116 is provided with a common voltage signal with a negative polarity and the controllable switch 142 is switched off under control of the control signal Vr. Because no touch sensing element 109 is disposed within the corresponding row of pixel unit and no touch sensing signal is provided to the touch sensing line 114, the processing module 141 can not obtain the touch sensing signal from the touch sensing line 114.

During an (N+1)th frame, when the scanning line Gi−1 is provided with the scanning signal, the common electrode layer 116 is provided with a common voltage signal with a negative polarity and the controllable switch 142 is switched off under control of the control signal Vr. Due to the negative polarity common voltage signal, the switch member 123 is on off-state, and the processing module 141 can not read the touch sensing signal from the touch sensing line 114. Further, when the next scanning line Gi is provided with the scanning signal, because no touch sensing element 109 is disposed within the corresponding row of pixel unit and no touch sensing signal is provided to the touch sensing line 114, the processing module 141 still can not obtain the touch sensing signal from the touch sensing line 114.

During the (N+2)th frame, the touch sensing display device 100 repeats all of actions of the Nth frame.

With the above-described configuration, when the corresponding scanning line Gi−1 coupled to the touch sensing element 109 is provided with the scanning signal, the common electrode layer 116 is provided with a common voltage signal with a positive polarity, and the controllable switch 142 of the processing module 141 is switched on. Accordingly, the processing module 141 can only read and process the touch sensing signal transmitted through the touch sensing line 114. Because the common electrode layer 116 is restricted to receive the common voltage signal with positive polarity when the processing of the touch sensing signals is carried out, the AC common voltage signal has little influence on the touch sensing signal, and therefore, the stability and reliability of the touch sensing display device 100 can be improved.

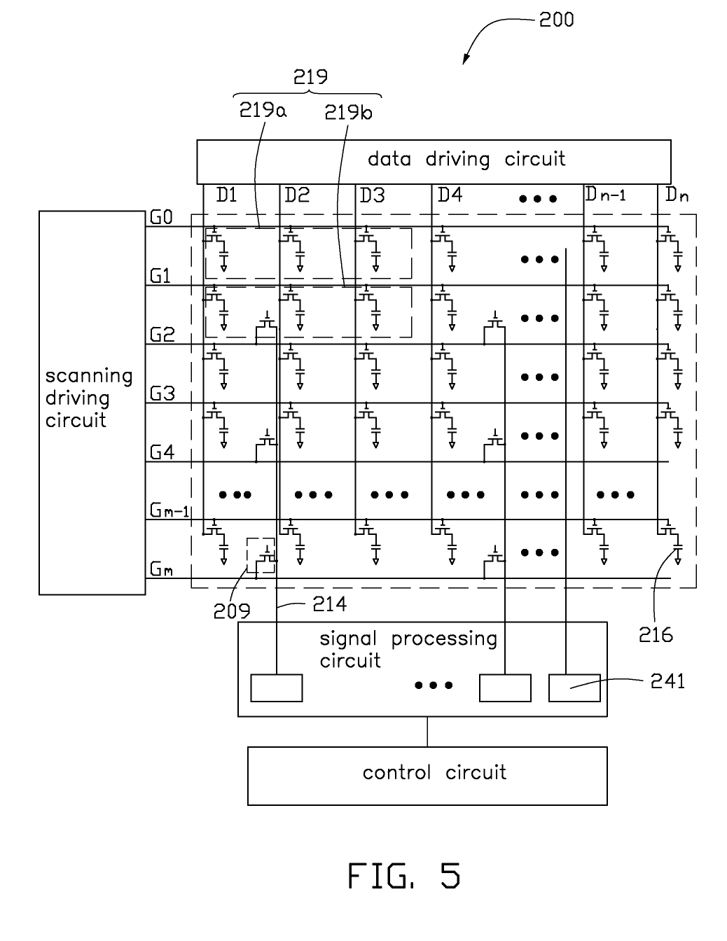

Referring to FIG. 5, a partial circuit diagram of a touch sensing display device according to a second embodiment of the present disclosure is shown. The touch sensing display device 200 is similar to the above-described touch sensing display device 100, differing in that: a touch sensing element 209 is disposed in a pixel unit of a second touch display sub-unit 219b, and the touch sensing element 209 is electrically coupled to the scanning line Gi (i denotes an odd number).

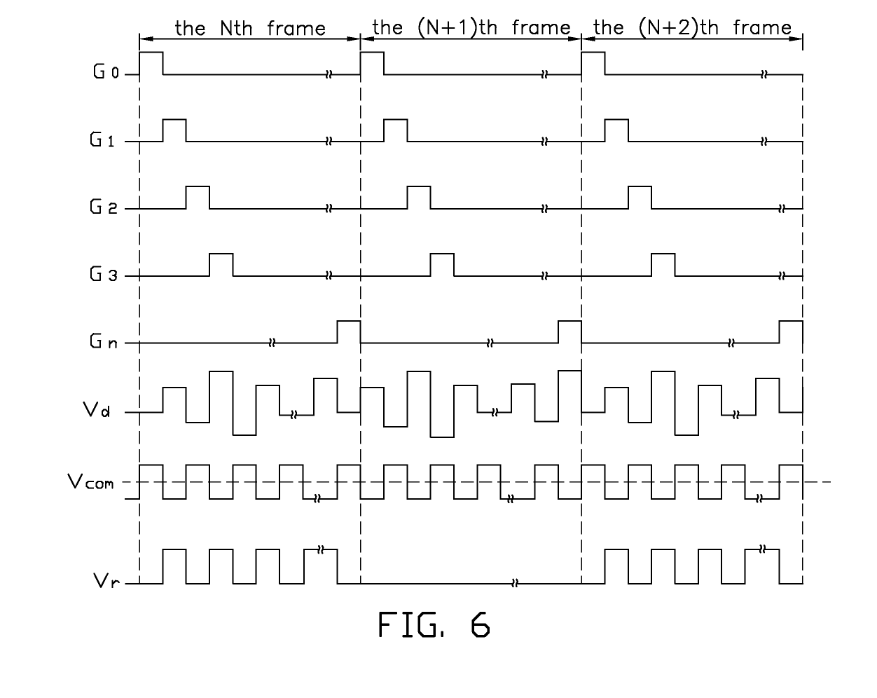

Referring to FIG. 6, waveforms of driving signals of the touch sensing display device of FIG. 5 is shown. In operation, the controllable switch of the processing module 241 is switched on when the corresponding scanning line Gi coupled to the touch sensing element 209 is provided with the scanning signal and the common electrode layer 216 is provided with a common voltage signal with a negative polarity. Accordingly, the processing module 241 can only read and process the touch sensing signal transmitted through the touch sensing line 214 when the common electrode layer 216 is provided with a common voltage signal with the negative polarity. Thus, the AC common voltage signal also has little influence on the touch sensing signal.

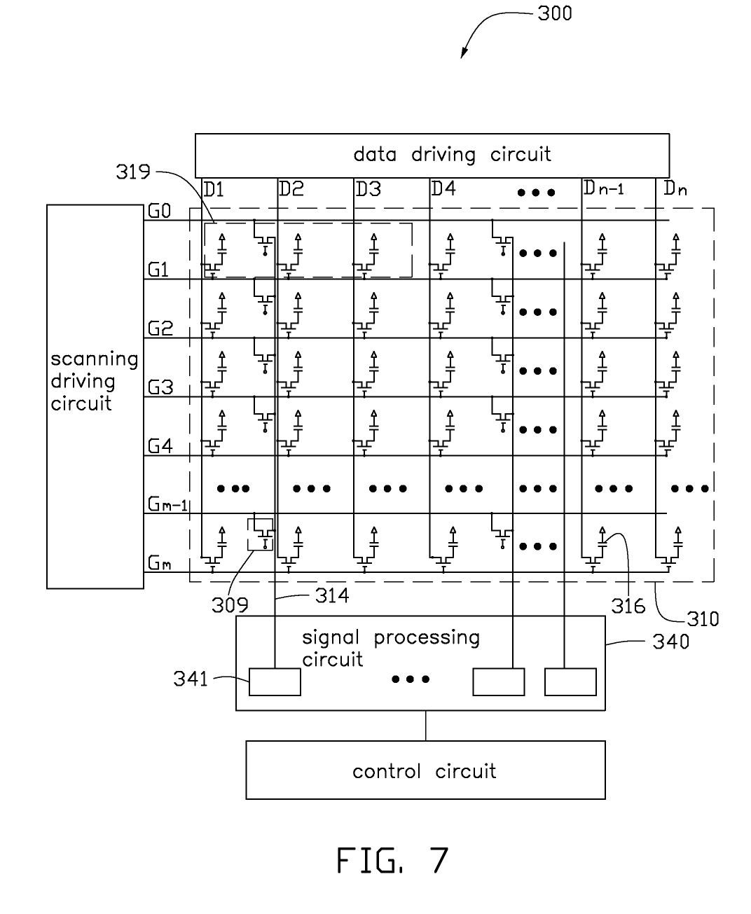

Referring to FIG. 7, a partial circuit diagram of a touch sensing display device according to a third embodiment of the present disclosure is shown. The touch sensing display device 300 is similar to the above-described touch sensing display device 100, differing in that each touch display unit 319 includes p×q pixel units (where p=3, q=1 in one embodiment), and a touch sensing element 309 is disposed in a selected pixel unit therein. The touch sensing element 309 is electrically coupled to a corresponding scanning line G0-Gm, and is also electrically coupled to a processing module 341 of a signal processing circuit 340 via a corresponding touch sensing line 314.

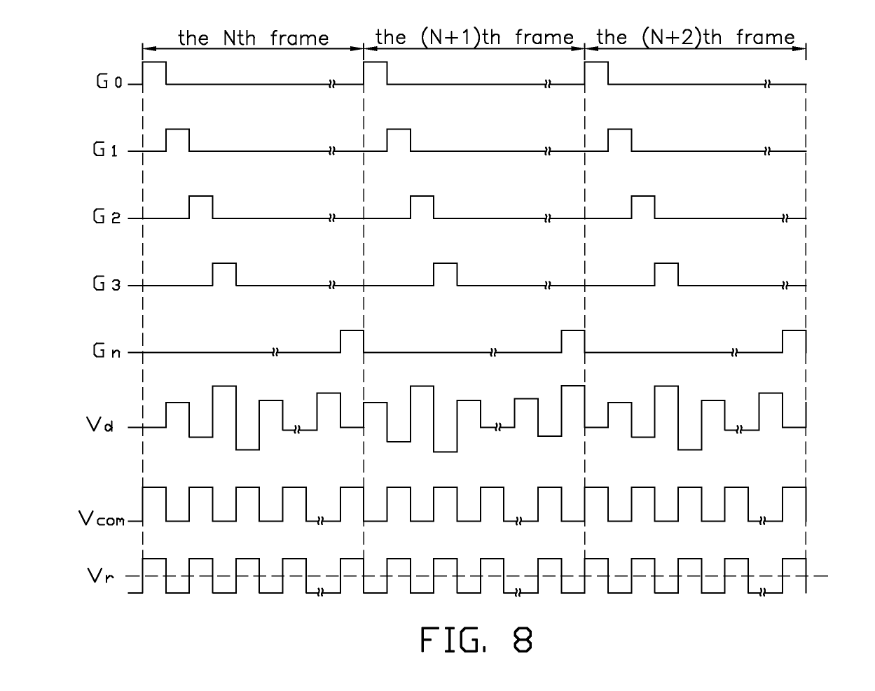

Referring to FIG. 8, waveforms of driving signals of the touch sensing display device of FIG. 7 is shown. In operation, during the Nth frame, when the scanning line Gi−1 is provided with the scanning signal, the common electrode layer 316 is provided with a common voltage signal with a positive polarity and the processing module 341 can read and process a touch sensing signal from the touch sensing line 314, in this situation, the touch sensing signal is provided by the touch sensing element 309 disposed with the pixel unit corresponding to the scanning line Gi−1. During the (N+1)th frame, when the scanning line Gi is provided with the scanning signal, the common electrode layer 316 is provided with a common voltage signal with a positive polarity, the processing module 341 can still read and process a touch sensing signal from the touch sensing line 314, in this situation, the touch sensing signal is provided by the touch sensing element 309 disposed with the pixel unit corresponding to the scanning line Gi.

Compare to the first and second embodiment, the processing module 341 can read and process the touch sensing signal in each frame time, a read frequency of the signal processing circuit 340 is increased, and the stability and reliability of the touch sensing display device 300 can be further improved.

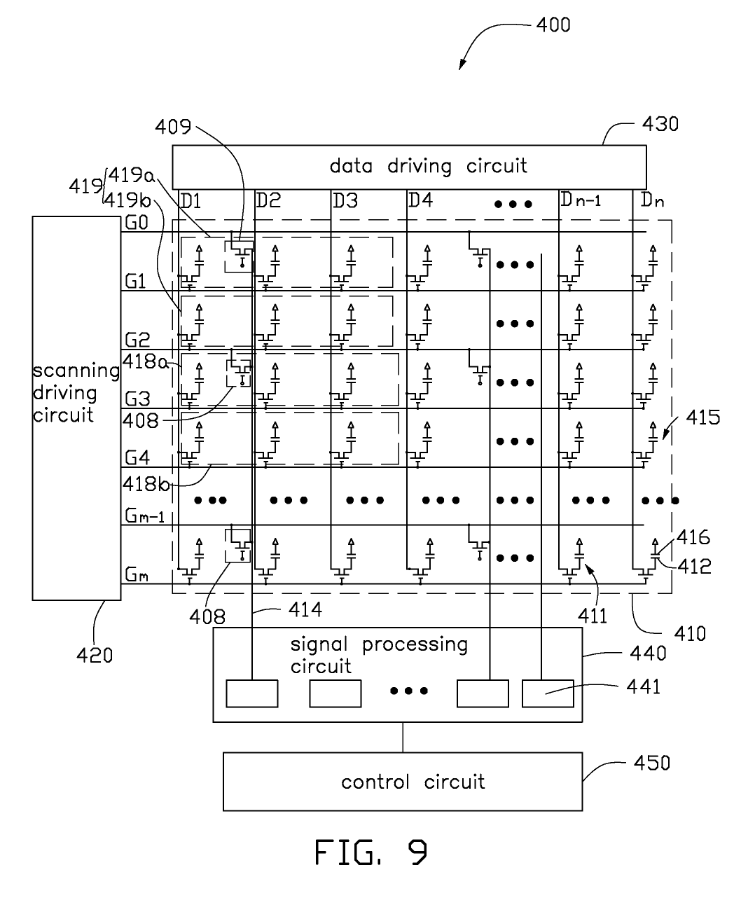

FIG. 9 is a partial circuit diagram of a touch sensing display device according to a fourth embodiment of the present disclosure. The touch sensing display device 400 includes a touch panel 410, a scanning driving circuit 420, a data driving circuit 430, a signal processing circuit 440, and a control circuit 450.

The touch panel 410 can be an LCD panel with touch sensing elements built therein, and includes a total m+1 parallel scanning lines G0˜Gm, a total n parallel data lines D1˜Dn, and a total m×n pixel units Pij arranged as a matrix distribution (where i, j respectively represent the ith row and the jth column of the pixel matrix, and 1≦i≦m 1≦j≦n). In particular, the scanning lines G0˜Gm may be perpendicular to the data lines D1˜Dn, and the pixel units Pij are defined by intersection of the scanning lines G0˜Gm and the data lines D1˜Dn.

Each pixel unit Pij includes a thin film transistor (TFT) 411 and a pixel electrode 412. A gate electrode of the TFT 411 is electrically connected to the scanning driving circuit 420 via a corresponding scanning line Gi (1≦i≦m), a source electrode of the TFT 411 is electrically connected to the data driving circuit 430 via a corresponding data line Dj (1≦j≦n), and a drain electrode of the TFT 411 is electrically connected to the pixel electrode 412. Moreover, in an exemplary embodiment, the touch panel 410 may further include a common electrode layer 416. The common electrode layer 416 may includes a plurality of common electrodes 416, and each common electrode 416 is configured in a respective pixel unit. In each pixel unit, the pixel electrode 412, the common electrode 416, and a liquid crystal layer (not shown) located between the pixel electrode 412 and the common electrode 416 cooperatively constitute a liquid crystal capacitor 415.

The m×n pixel units can be divided into a plurality of touch display units 419 and a plurality of coupling display units 418. In one embodiment, the touch display units 419 and coupling display units 418 may also be arranged as a matrix distribution, each touch display unit 419 includes p×q pixel units and each coupling display unit 418 also includes p×q pixel units, where, for example, p=3, q=2, in the illustrated embodiment. In detail, each touch display unit 419 may include a first touch display sub-unit 419a and a second touch display sub-unit 419b adjacent to each other, and each coupling display unit 418 may include a first coupling display sub-unit 418a and a second coupling display sub-unit 418b adjacent to each other. For example, the first touch display sub-unit 419a and the second touch display sub-unit 419b may be respectively arranged in an ith row and an (i+1)th row of the pixel matrix, and the first coupling display sub-unit 418a and the second coupling display sub-unit 418b may be respectively arranged in an (i+2)th row and an (i+3)th row of the pixel matrix in the illustrated embodiment, i denotes an odd number. Each touch display sub-unit 419a, 419b may be constituted by 3*1 pixel units, which may respectively correspond to a red pixel unit, a green pixel unit, and a blue pixel unit. Each coupling display sub-unit 418a, 418b may be constituted by 3*1 pixel units, which may also respectively correspond to a red pixel unit, a green pixel unit, and a blue pixel unit.

Moreover, a touch sensing element 409 may be disposed in each touch display unit 419. The touch sensing element 409 may be located in the first touch display sub-unit 419a of the touch display unit 419, for example, be located within a selected one pixel unit Pij of the first touch display sub-unit 419a. The touch panel 410 can further include a plurality of touch sensing lines 414 parallel to the data line D1˜Dn. The touch sensing element 409 may provide a touch sensing signal to the signal processing circuit 440 by means of a corresponding one of the touch sensing line 414. In particular, the touch sensing element 409 located in the ith row of the pixel matrix may be electrically coupled to the scanning line Gi−1, and further be electrically coupled to the signal processing circuit 440 via the corresponding touch sensing line 414. Additionally, in one embodiment, all the touch sensing elements 409 located in a same column of pixel matrix is electrically coupled to the signal processing circuit 440 via a same touch sensing line 414.

A coupling sense element 408 may be disposed in each coupling display unit 418. The coupling sense element 408 may be located in the first coupling display sub-unit 418a of the touch display unit 418, for example, be located within a selected one pixel unit Pij of the first coupling display sub-unit 418a. The coupling sense element 408 may provide a coupling sense signal to the signal processing circuit 440 by means of a corresponding one of the touch sensing line 414. In particular, the coupling sense element 408 located in the (i+2)th row of the pixel matrix may be electrically coupled to the scanning line Gi+1, and further be electrically coupled to the signal processing circuit 440 via the touch sensing line 414 corresponding to the touch sensing element 409. Additionally, in one embodiment, all the touch sensing elements 409 and the coupling sense elements 408 located in a same column of pixel matrix is electrically coupled to the signal processing circuit 440 via a same touch sensing line 414.

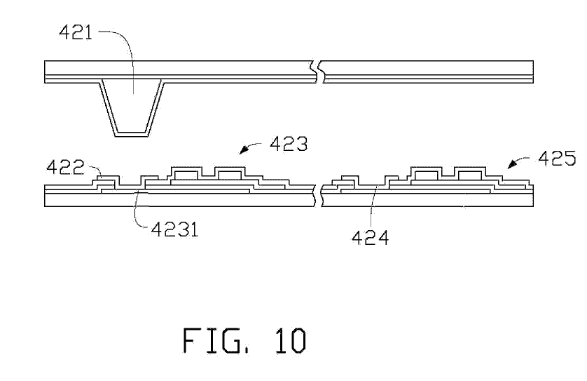

Referring to FIG. 10, in one embodiment, the touch sensing element 409 is same as the above-described touch sensing element 109. For example, the touch sensing element 409 may include a switch member 423 formed on a TFT substrate (not labeled), a touch sensing electrode 422 formed on the TFT substrate and adjacent to the switch member 423, and a protrusion 421 formed on a CF substrate (not labeled) and located at a position opposite to the touch sensing electrode 422. The protrusion 421 is covered by a common electrode 416 formed on the CF substrate. The switch member 423 includes a control terminal 4231, which may be applied with an activation signal when an operator or user performs a touch operation onto the touch display unit 419 and thereby enabling the switch member 423 to be switched on.

In one embodiment, the switch member 423 may have a TFT structure having a gate electrode, a source electrode, and a drain electrode. The gate electrode of the switch member 423 may serve as the control terminal 4231, which extends to the touch sensing electrode 422 and thereby being electrically coupled to the touch sensing electrode 422. The source electrode of the switch member 423 is electrically coupled to the scanning line Gi−1, and the drain electrode of the switch member 423 is electrode coupled to the touch sensing line 414. With this configuration, when a user perform a touch operation onto the touch display unit 419, an external force may be introduced to the touch sensing element 409, and the protrusion 421 is pressed such that the common electrode 416 covering the protrusion 421 contacts the touch sensing electrode 422. Accordingly, a common voltage applied to the common electrode 416 by a common electrode circuit is transmitted, through the touch sensing electrode 422, to the control terminal 4231 of the switch member 423, and the common voltage acts as an activation signal to control the switch member 423 to be switched on. As such, the scanning signal transmitted in the scanning line Gi−1 servers as the touch sensing signal, and is provided to the signal processing circuit 440 through the touch sensing line 414.

A structure of the coupling sense element 408 in the touch display unit 418 is similar to the touch sense element 409, and different only in that the coupling sense element 408 does not include the above-described protrusion 421. In detail, the coupling sense element 408 may include a switch member 425 formed on a TFT substrate (not labeled) and a touch sensing electrode 424 formed on the TFT substrate and adjacent to the switch member 425. Due to no protrusion, the switch member 425 of the coupling sense element 408 can not be switched on when an operator or user performs a touch operation onto the coupling display unit 418. Accordingly, the coupling sense element 408 can provide a fixed coupling sense signal to the signal processing circuit 440 through the touch sensing line 414.

The signal processing circuit 440 includes a plurality of processing modules 441, and each of the processing modules 441 is electrically coupled to a respective column of touch display units 419 and coupling display units 418 via corresponding touch sensing line 414. The processing module 441 is configured to process a touch sensing signal and a coupling sense signal provided thereto through the touch sensing line 414.

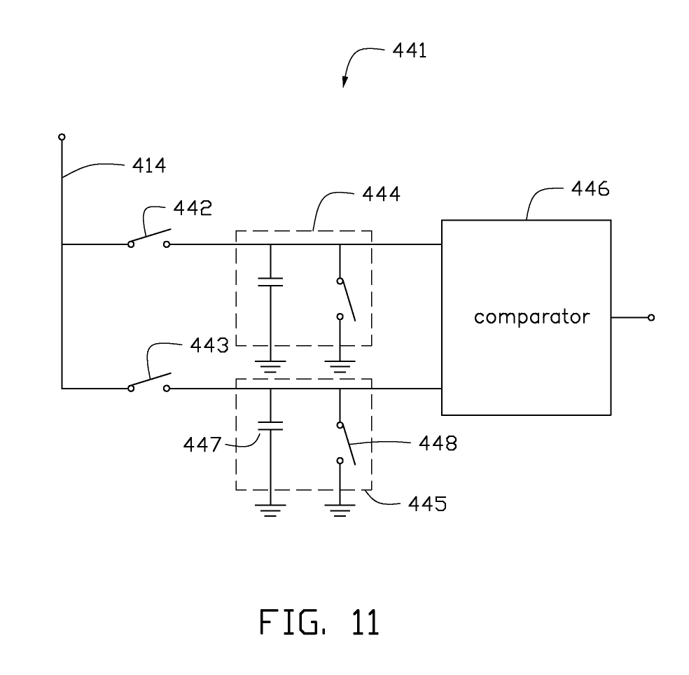

FIG. 11 schematically illustrates a circuit diagram of the processing module 441 according to one embodiment of the present disclosure. In the illustrated embodiment, the processing module 441 includes a first controllable switch 442, a first storage unit 444, a second controllable switch 443, a second storage unit 445, and a comparator 446. One end of the first controllable switch 442 is electrically coupled to the touch sensing line 414 for receiving the transmitted touch sensing signal, and the other end of the first controllable switch 442 is electrically coupled to a first terminal of the comparator 446 via the storage unit 444. One end of the second controllable switch 443 is also electrically coupled to the touch sensing line 414 for receiving the transmitted coupling sense signal, and the other end of the second controllable switch 443 is electrically coupled to a second terminal of the comparator 446 via the storage unit 445.

The first controllable switch 442 and the second controllable switch 443 can be switched on or switched off under control of a drive timing of the touch sensing display device 400, so as to determine whether to read and process the touch sensing signal and the coupling sense signal transmitted by the touch sensing line 414. Each of the first storage unit 444 and the second storage unit 445 may include a storage capacitor 447 and a switch 448 electrically coupled in parallel between the first terminal of the comparator 146 and the ground. The comparator 446 may be a differential amplification comparator, which includes an in-phase input terminal serving as the first terminal, an inverting-phase input terminal serving as the second terminal, and an output terminal electrically coupled to the control circuit 450. The comparator 146 is configured to generate the touch position indication signal by comparing the touch sensing signal with the coupling reference signal.

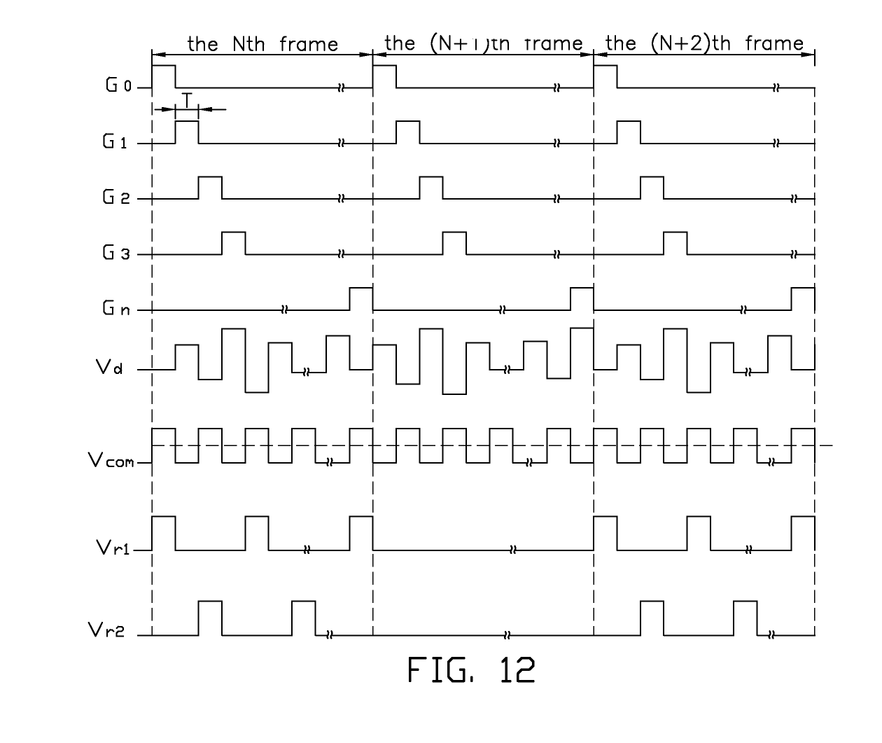

FIG. 12 illustrates waveforms of driving signals of the touch sensing display device 400. The driving signals include scanning signals provided to the scanning lines G0-Gm, a data signal (represented as Vd) provided to one of the data lines D1-Dn, a common voltage signal (represented as Vcom) provided to the common electrode layer 116, a first control signal (represented as Vr1) applied to the first controllable switch 442, and a second control signal (represented as Vr2) applied to the second controllable switch 443. Each of the first control signal Vr1 and the second control signal Vr2 can for example be a square wave signal with a high level signal and a low level signal alternately with each other, the first controllable switch 442 or the second controllable switch 443 is controlled to be switched on when the high level signal is applied thereto, and be switched off when the low level signal is applied thereto.

An operation of the touch sensing display device 400 in responsive to a touch operation performed thereon is described as follow with reference to FIGS. 9-12. When a user operating the touch sensing display device 400 performs a touch operation onto the touch sensing display device, the touch sensing element 409 located in a position in which the touch operation is designated (i.e., a touch position) may senses the touch operation, and the protrusion 420 of the touch sensing element 409 is pressed to enable the common electrode layer 416 to contact the touch sensing electrode 422, such that the switch element 423 is switched on. During the corresponding scanning line Gi−1 coupled to the touch sensing element 409 being provided with the scanning signal, the touch sensing element 409 can provide the scanning signal as a touch sensing signal to the touch sensing line 414. Moreover, the coupling sense element 408 can provide a fixed coupling sense signal to the touch sensing line 414 at anytime.

Specifically, during the Nth frame, when the scanning line Gi−1 is provided with the scanning signal, the common electrode layer 416 is provided with a common voltage signal with a positive polarity and the first controllable switch 442 is switched on under control of the first control signal Vr1. Accordingly, the processing module 441 can read a touch sensing signal from the touch sensing line 414 and store the touch sensing signal in the first storage unit 444. When the scanning line Gi+1 is provided with the scanning signal, the common electrode layer 416 is also provided a common voltage signal with a positive polarity and the second controllable switch 443 is switched on under control of the second control signal Vr2. Accordingly, the processing module 441 can read the coupling sense signal transmitted by the touch sensing line 414 and store the touch sensing signal in the second storage unit 445. The comparator 446 then compares the touch sensing signal with the coupling sense signal, and outputs a touch position indication signal to the control circuit 450, such that the control circuit 450 can determine coordinates of the touch position. The control circuit 450 can further execute corresponding touch operations according to the coordinates of the touch position, and control the touch sensing display device 400 or electronic device using the touch sensing display device 400 to perform corresponding actions.

During the (N+1)th frame, when the scanning line Gi−1 is provided with the scanning signal, the common electrode layer 416 is provided with a common voltage signal with a negative polarity and the first controllable switch 442 is switched off under control of the first control signal Vr1, the processing module 441 can not read the touch sensing signal from the touch sensing line 414. Further, when the next scanning line Gi+1 is provided with the scanning signal, although the common electrode layer 416 is provided with a common voltage signal with a negative polarity and the second controllable switch 443 is switched off under control of the second control signal Vr2, the processing module 441 can not read the coupling sense control signal from the touch sensing line 414.

During the (N+2)th frame, the touch sensing display device 400 repeats all of actions of the Nth frame.

Comparing with the first, second, and third embodiment, the processing module 441 reads the fixed coupling sense signal as a reference signal, and compares the touch sensing signal with the coupling sense signal so as to output the touch position indication signal. Because the structure of the coupling sense element 408 is similar to the touch sense element 409, the coupling sense signal can filter the interference signals among the touch sensing signal. Thus, the stability and reliability of the touch display device 400 can be further improved.

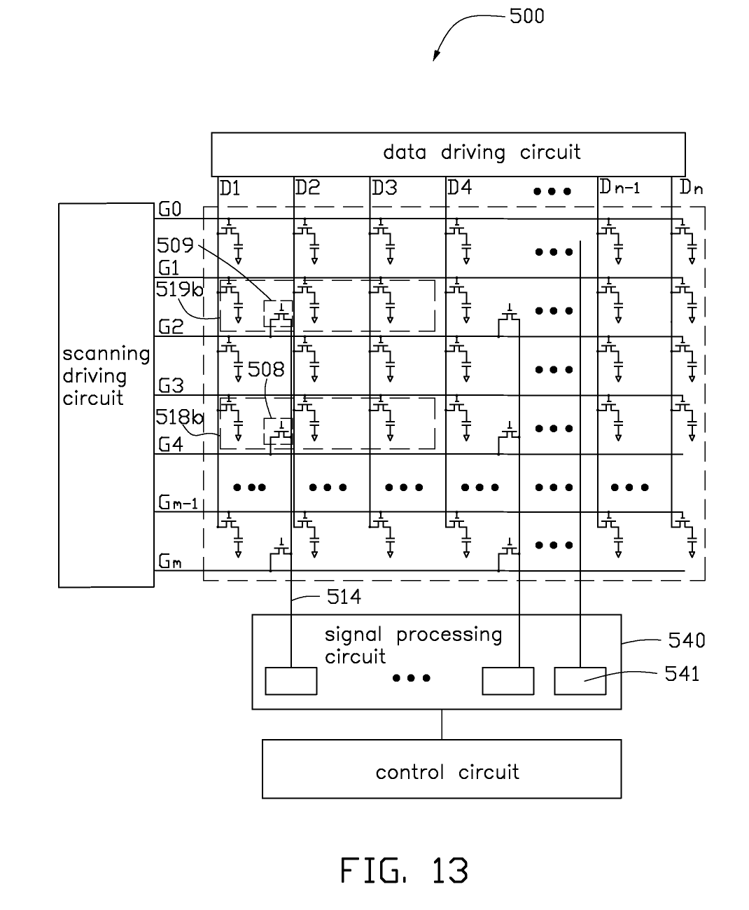

FIG. 13 schematically illustrates a partial circuit diagram of a touch sensing display device according to a fifth embodiment of the present disclosure. The touch sensing display device 500 is similar to the above-described touch sensing display device 400, differing in that a touch sensing element 509 is disposed in a pixel unit of a second touch display sub-unit 519b and electrically coupled to the scanning line Gi, a coupling sense element 508 is disposed in a pixel unit of a second coupling display sub-unit 518b and electrically coupled to the scanning line G(i+2).

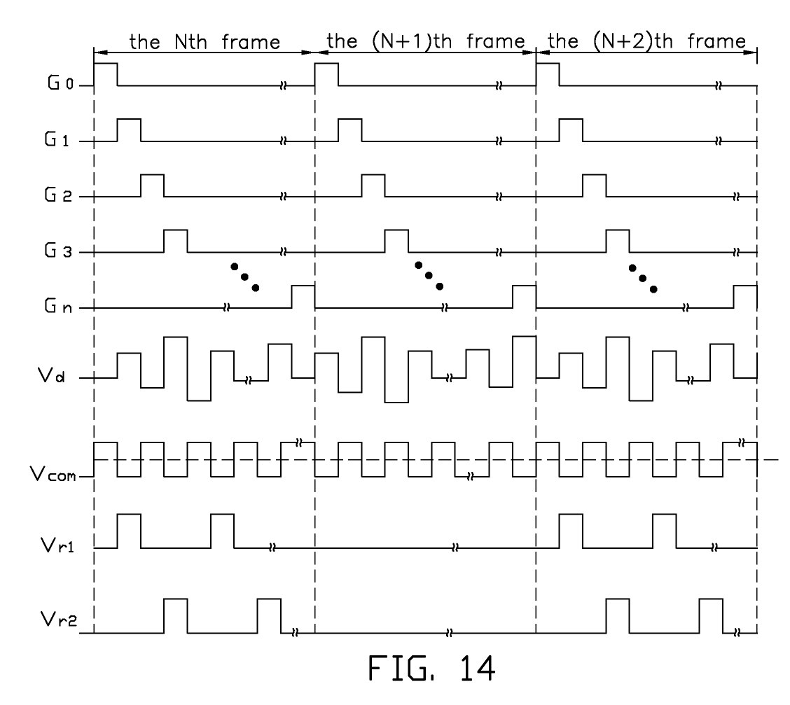

Referring to FIG. 14, waveforms of driving signals of the touch sensing display device of FIG. 13 is shown. In operation, a first controllable switch of a processing module 541 is switched on when the corresponding scanning line Gi is provided with the scanning signal and the common electrode layer 516 is provided with a common voltage signal with a negative polarity, and a second controllable switch of a processing module 541 is switched on when the corresponding scanning line Gi+2 is provided with the scanning signal and the common electrode layer 516 is provided with a common voltage signal with a negative polarity. Accordingly, the processing module 541 can only read and process a touch sensing signal and a coupling sense signal transmitted by the touch sensing line 514 when the common electrode layer 516 is provided with a common voltage signal with the negative polarity.

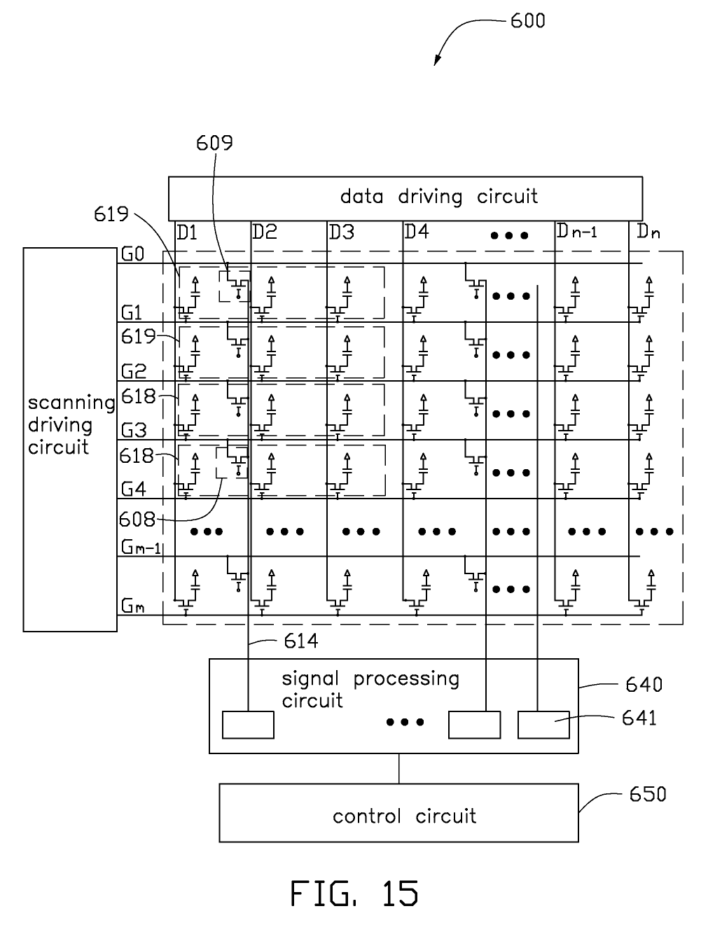

FIG. 15 schematically illustrates a partial circuit diagram of a touch sensing display device according to a sixth embodiment of the present disclosure. The touch sensing display device 600 is similar to the above-described touch sensing display device 400, differing in that each touch display unit 619 includes p×q pixel units, where p=3, q=1, in one embodiment; a touch sensing element 609 is disposed in a pixel unit, each coupling display unit 618 includes p×q pixel units, and a coupling sense element 608 is disposed in a pixel unit. The touch display units 619 located in two adjacent row and the same column constitute a touch display unit group, and the coupling display units 618 located in two adjacent row and the same column constitute a touch display unit group constitute a coupling display module. The touch display unit groups and the coupling display unit groups located in a same column are alternately disposed with each other.

The touch sensing element 609 is electrically coupled to a corresponding scanning line Gi−1 or Gi, and is also electrically coupled to a processing module 641 of a signal processing circuit 640 via a corresponding touch sensing line 614. The coupling sense element 608 is electrically coupled to a corresponding scanning line Gi+1 or Gi+2, and is also electrically coupled to a processing module 641 of a signal processing circuit 640 via a corresponding touch sensing line 614.

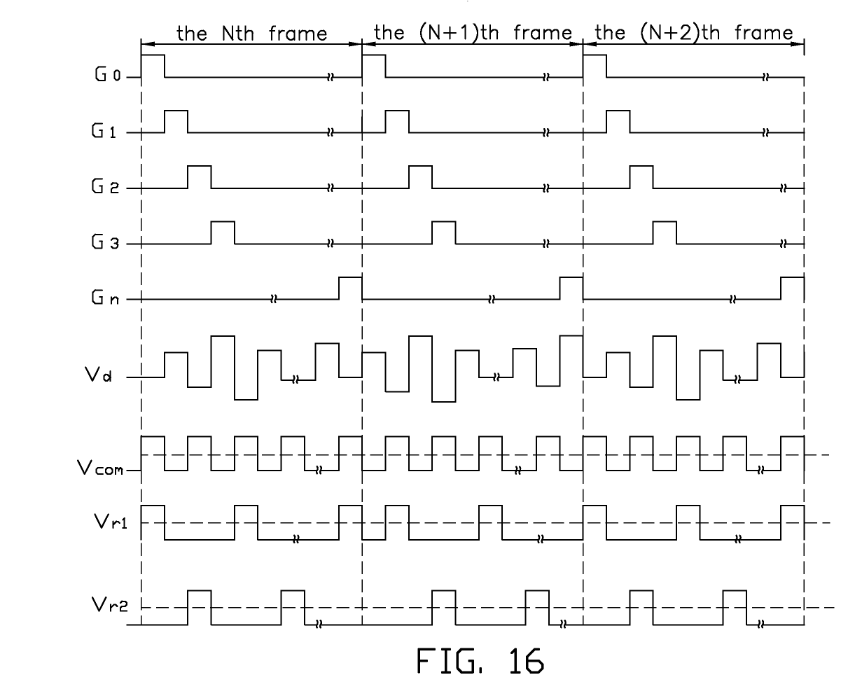

Referring to FIG. 16, waveforms of driving signals of the touch sensing display device of FIG. 8 is shown. In operation, during the Nth frame, when the scanning line Gi−1 is provided with the scanning signal, the common electrode layer 616 is provided with a common voltage signal with a positive polarity, the processing module 641 can read and process a touch sensing signal from the touch sensing line 614. Moreover, when the scanning line Gi+1 is provided with the scanning signal, the common electrode layer 616 is provided with a common voltage signal with a positive polarity, the processing module 641 can read and process a coupling sense signal transmitted by the touch sensing line 614. Then, the processing module 641 processes the touch sensing signal and the coupling sense signal and outputs a corresponding touch position indication signal to the control circuit 650.

During the (N+1)th frame, when the scanning line Gi is provided with the scanning signal, the common electrode layer 616 is provided with a common voltage signal with a positive polarity, the processing module 641 can read and process a touch sensing signal transmitted by the touch sensing line 614. Moreover, when the scanning line Gi+2 is provided with the scanning signal, the common electrode layer 616 is provided with a common voltage signal with a positive polarity, the processing module 641 can read and process a coupling sense signal from the touch sensing line 614. Then, the processing module 641 processes the touch sensing signal and the coupling sense signal and outputs a corresponding touch position indication signal to the control circuit 650.

Compare to the fourth and fifth embodiment, the processing module 641 can read and process the touch sensing signal in each frame time, a read frequency of the signal processing circuit 640 is increased, and the stability and reliability of the touch sensing display device 600 can be further improved.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A touch sensing display device, comprising:
a touch panel comprising a plurality of scanning lines, a plurality of data lines, and a plurality of pixel units defined by the scanning lines and the data lines, the pixel units cooperatively constitute a plurality of touch display units each comprising a touch sensing element, the touch sensing element being configured for providing a touch sensing signal when a touch operation is applied to the corresponding touch display unit; and
a signal processing circuit configured for processing the touch sensing signal provided by the touch sensing element;
wherein the touch sensing element is electrically coupled to a corresponding scanning line, and electrically coupled to the signal processing circuit via a touch sensing line;
wherein a common voltage signal is provided to the pixel unit, the common voltage signal is an inverse-polarity signal with a first polarity and an inversed second polarity, when the scanning line electrically coupled to the touch sensing element is provided with a scanning signal and the common voltage signal with the first polarity, the touch sensing signal generated by the touch sensing element is outputted to the signal processing circuit to enable the signal process circuit to generate a touch position indication signal.

2. The touch sensing display device of claim 1, wherein the touch panel further comprises a common electrode layer, the common voltage signal is provided to the pixel unit via the common electrode layer, and the touch sensing element comprises a switch member and a protrusion covered by the common electrode layer; when the touch operation is applied to the touch display unit, the common electrode layer covering the protrusion is pressed to electrically connect a control terminal of the switch member and whereby the switch member is switched on, and the touch sensing signal is outputted to the signal process circuit via the switch member and the touch sensing line.

3. The touch sensing display device of claim 2, wherein the touch sensing element further comprises a touch sensing electrode extending from the control terminal of the switch member, and when the touch operation is applied to the touch display unit, the common electrode layer covering the protrusion is pressed to contact touch sensing electrode to switch the switch member on by use of the common voltage signal applied to the common electrode layer.

4. The touch sensing display device of claim 2, wherein the touch display units are arranged as a matrix distribution, and the touch sensing elements located in a same column of the matrix are electrically coupled to the signal processing unit via a same touch sensing line.

5. The touch sensing display device of claim 4, wherein each of the touch display units includes 3*2 pixel units located in two adjacent row, and all the touch sensing element are disposed within the pixel units located in odd rows, or disposed within the pixel units located in even rows.

6. The touch sensing display device of claim 4, wherein each of the touch display units includes 3*1 pixel units located in a same row, and the touch sensing element is disposed within a selected one of the 3*1 pixel units.

7. The touch sensing display device of claim 4, wherein the signal processing unit comprises a plurality of processing modules, each processing module is connected to each touch sensing line correspondingly, and is configured to process the touch sensing signals provided by a column of touch sensing elements connected to the touch sensing line.

8. The touch sensing display device of claim 7, wherein the processing module comprises a controllable switch, a storage unit and a comparator, the touch sensing signal transmitted through the corresponding touch sensing line is provided to a first input terminal of the comparator via the controllable switch and the storage unit, a predetermined reference signal is inputted to a second input terminal of comparator, and the comparator is configured to generate the touch position indication signal by comparing the touch sensing signal with the predetermined reference signal.

9. The touch sensing display device of claim 1, wherein a plurality of coupling display units are defined by the pixel units, each coupling display unit corresponds to each touch display unit, and comprises a coupling sense element, the coupling display unit is electrically coupled the corresponding scanning line, and electrically coupled to the signal processing circuit via the corresponding touch sensing line, and is configured to provide a coupling signal to the signal processing circuit;
wherein when the corresponding scanning line is provided with a scanning signal and the common voltage signal is the first polarity signal, the signal processing circuit reads the coupling signal from the corresponding touch sensing line, and filter interference signals from the touch sensing signal according to the coupling signal.

10. The touch sensing display device of claim 9, wherein the coupling sense element comprises a switch member, and the common voltage signal is not applied to the switch member when the touch operation is applied to the corresponding coupling sense element.

11. The touch sensing display device of claim 10, wherein the coupling sense element further comprises an extending electrode connecting a control terminal of the switch member of the coupling sense element.

12. The touch sensing display device of claim 9, wherein the touch display units and the coupling display units cooperatively arranged as a matrix distribution and the touch sensing elements and the coupling sense elements located in a same column of the matrix are electrically coupled to the signal processing unit via a same touch sensing line.

13. The touch sensing display device of claim 12, wherein the signal processing unit comprises a plurality of processing modules, each processing module is connected to each touch sensing line correspondingly, and is configured to process the touch sensing signals provided by a column of touch sensing elements connected to the touch sensing line according to the coupling sense signals provided by the corresponding coupling sense elements.

14. The touch sensing display device of claim 13, wherein the processing module comprises a first controllable switch, a first storage unit, a second controllable switch, a second storage unit, and a comparator, the touch sensing signal transmitted through the corresponding touch sensing line is provided to a first input terminal of the comparator via the first controllable switch and the first storage unit, the coupling sense signal transmitted through the same touch sensing line is provided to a second input terminal pf the comparator via the second controllable switch and the second storage unit.

15. The touch sensing display device of claim 12, wherein each of the touch display units and the coupling display units includes 3*2 pixel units located in two adjacent row, the touch display units and the coupling display units located in a same column are alternately disposed with each other, and all the touch sensing elements and the coupling sense elements are disposed within the pixel units located in odd rows, or disposed within the pixel units located in even rows.

16. The touch sensing display device of claim 12, wherein each of the touch display units and the coupling display unit includes 3*1 pixel units located in a same row, each two of the touch display units located in two adjacent row constitute a touch display unit group, each two of the coupling display units located in two adjacent row constitute a coupling display unit group, and the touch display unit groups and the coupling display unit groups located in a same column are alternately disposed with each other.

17. The touch sensing display device of claim 1, wherein one of the first polarity and the second polarity is a positive polarity, and the other one is a negative polarity.

18. The touch sensing display device of claim 1, further comprising a control circuit, wherein the control circuit is electrically coupled to the signal processing circuit for receiving the touch position indication signal, and the control circuit is configured to determine coordinates of the touch position according to the touch position indication signal and execute corresponding touch operations according to the coordinates of the touch position.

19. The touch sensing display device of claim 1, further comprising a scanning driving circuit electrically coupled to the scanning lines and a data driving circuit electrically coupled to the data lines.

20. A touch sensing display device, comprising:
a touch panel comprising a common electrode layer, a plurality of scanning lines, a plurality of data lines, and a plurality of pixel units defined by the scanning lines and the data lines, the pixel units cooperatively constitute a plurality of touch display units each comprising a touch sensing element, the touch sensing element being configured for providing a touch sensing signal when a touch operation is applied to the corresponding touch display unit, the touch sensing element is electrically coupled to a corresponding scanning line, and electrically coupled a touch sensing line; and
a signal processing circuit configured for processing the touch sensing signal provided by the touch sensing element, and the signal processing circuit electrically coupled to the touch sensing element via the touch sensing line;
wherein the common electrode layer is provided with a common voltage signal, the common voltage signal is an inversing-polarity signal with a first polarity signal and an inversed second polarity signal alternating with each other, when the scanning line electrically coupled to the touch sensing element is provided with a scanning signal and the common voltage signal is the first polarity signal, the touch sensing signal generated by the touch sensing element is outputted to the signal processing circuit to enable the signal process circuit to generate a touch position indication signal.
